(19) United States
(12) Patent Application Publication
(10) Pub. No.: US 2026/0317049 A1
(43) Pub. Date: Oct. 15, 2026

(54) CARBONATED BEVERAGE CARAFE

(71) Applicant: AWA Water, Inc., Redwood City, CA (US)

(72) Inventors: Cival Van Der Lubbe, Brooklyn, NY (US); Thomas Agarate, Lisboa (PT)

(73) Assignee: AWA WATER, INC., Redwood City, CA (US)

(21) Appl. No.: 19/639,915

(22) Filed: Apr. 6, 2026

Related U.S. Application Data
(63) Continuation-in-part of application No. 18/405,809, filed on Jan. 5, 2024, now abandoned.

(51) Int. Cl. B65D 85/73; B01F 23/2361; B01F 23/237; B01F 101/14; B65D 23/00; B65D 47/24; B65D 51/24; B65D 81/38

(52) U.S. Cl. CPC B65D 85/73; B01F 23/2361; B01F 23/237611; B65D 23/001; B65D 47/247; B65D 51/245; B65D 81/3841; B01F 2101/14

(57) ABSTRACT

In various embodiments disclosed herein, a carbonated beverage carafe includes a main body, a base, and a cap. The main body may be any shape desired by the user, but is typically cylindrical. The main body has a dual walled construction to maximize insulating capability. The cap is threaded on to the main body to seal the main body. The device includes a mating mechanism that allows the carafe to be installed in an external carbonation device. In various embodiments, the cap includes a push button device that unseals the carafe to allow liquid to be poured out of the carafe.

### CROSS REFERENCE TO RELATED APPLICATIONS

This application is a continuation-in-part and claims the priority benefit of co-pending U.S. application Ser. No. 18/405,809, filed Jan. 5, 2024.

### FIELD OF THE DISCLOSURE

The present disclosure relates generally to containers for liquids, and more particularly is a carafe designed specifically for carbonated beverages.

### SUMMARY

In various embodiments of the present disclosure, a carafe includes a main body, a base, and a cap. The main body may be any shape desired by the user, but is typically cylindrical. The cap is threaded on to the main body to seal the main body. The base includes a mating mechanism that allows the carafe to be installed in an external carbonation device.

### BRIEF DESCRIPTION OF THE DRAWINGS

The accompanying drawings, wherein like reference numerals refer to identical or functionally similar elements throughout the separate views, together with the detailed description below, illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a front perspective view of a carafe designed to accommodate carbonated beverages.

FIG. 2 is a front perspective view of the carafe showing two alternative tops and the base disassembled.

FIG. 3 is a front view of the device.

FIG. 4 is a bottom view of the device showing the carbonating device adaptive mechanism.

FIG. 5 is a detail view of the neck of the main body.

FIG. 6A is a sectional view of the upper part of the device illustrating the pouring mechanism in an open (pouring) position.

FIG. 6B is a sectional view of the upper part of the device illustrating the pouring mechanism in an open (sealed) position.

FIG. 7 is a perspective view showing the device as used in conjunction with a typical filling and carbonation device.

FIG. 8 is a perspective view of another embodiment of the device.

FIG. 9 is an exploded view of the device shown in FIG. 8.

FIG. 10 is a detail view of the upper end of the device.

FIG. 11 shows a sectional view of the device.

FIG. 12 is a detail view of the cap in position on the bottle.

FIG. 13 is a perspective view showing the device as used in conjunction with a typical filling and carbonation device.

### DETAILED DESCRIPTION

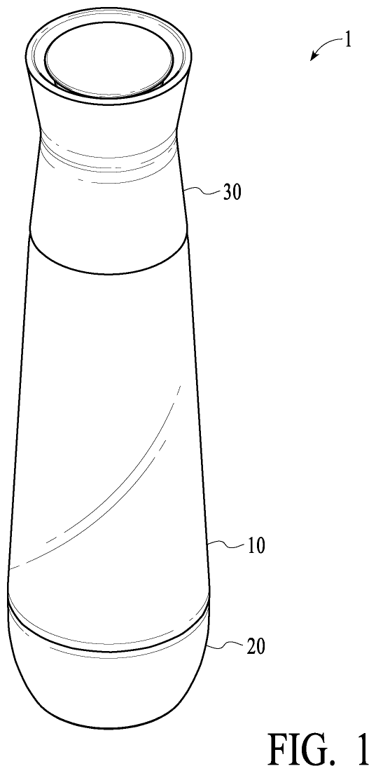

The present disclosure is directed to a vessel that holds liquids, a carafe 1 adapted to contain and pour carbonated beverages. Referring first to FIGS. 1-3, the carafe 1 includes a main body 10, a base element 20, and a cap 30.

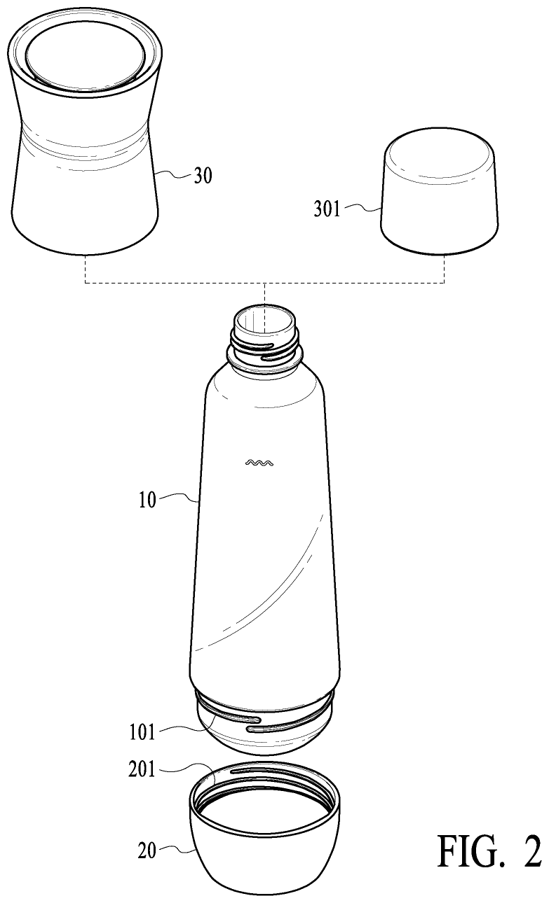

The base 20 is constructed to encase, support, and stabilize the bottom of the main body 10. The support of the base 20 on the main body 10 allows the carafe 1 to be safely placed on any flat surface. As illustrated in FIG. 2, a female thread 201 on the base 20 may be threaded onto a mating male thread 101 on the main body 10. Various other connecting mechanisms may be used to accomplish the connection of the base 20 to the main body 10, including friction fit constructions.

As shown in FIG. 2, the carafe 1 can have various designs for the cap 30, such as alternate cap 30′. The choice of style for the cap 30 is a matter of choice for the user of the device. It should be further noted that the carafe 1 can be manufactured in a variety of colors and materials, again, according to the choice of the user. Assigned colors can be used to designate a cap for a specific member of the household. Different colors can be used for different users.

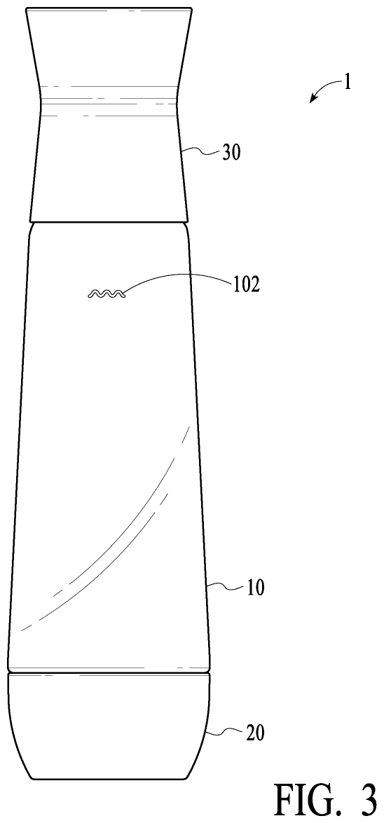

FIG. 3 illustrates the main body 10 as including a fill line 102. The fill line 102 allows the user to be cognizant of the practical volumetric limits of the carafe 1.

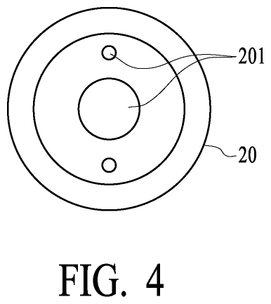

As shown in FIG. 4, the bottom of the base 20 may include one or more drain holes 201 to release condensation or spilled liquid from the device.

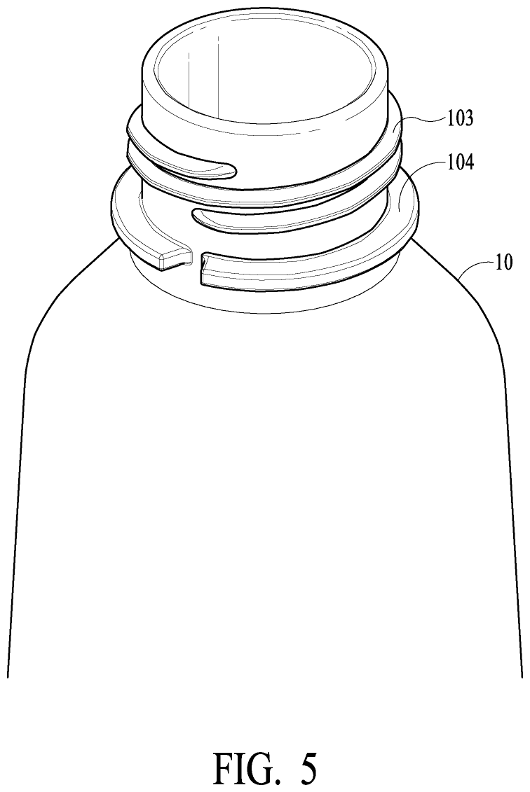

Referring now to FIG. 5, the upper end of the main body 10 includes a male thread 103 that mates with a female thread on a cap 30. A base ring 104 provides an anchor point for the cap 30, and enables adaptation to various carbonating devices. While those skilled in the art will readily recognize that many securing mechanisms can be used, in various preferred embodiments, the cap 30 and the main body 10 are joined with a threaded connection. The threaded connection allows the cap 30 to form an airtight seal with the main body 10, thereby maintaining the carbonation level of the fluid in the carafe 1. Moreover, the specific conformation shown in the drawings allows the carafe 1 to be used with most common filling and carbonation devices. Specifically, the Sodastreamtm device works well with the various embodiments described herein, as well as carbonators made by AWAtm, Aarketm, Philipstm, and Brittatm. This ability of the device to mate with the various carbonators allows the user to make soda at home using the carafe 1 in conjunction with a carbonator.

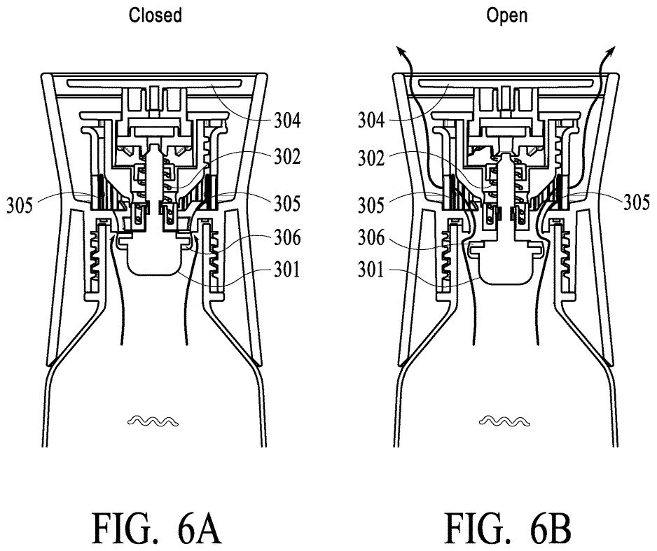

FIGS. 6A and 6B show the operation of a unique opening mechanism in the cap 30. FIG. 6A shows the cap 30 in a closed position. A central stopper 301 seals the opening in the top of the main body 10. The stopper 301 is spring 302 loaded against an upper securing block 303. An actuating button 304 is used to move the stopper 301 from the closed position shown in FIG. 6A to the open position shown in FIG. 6B.

When the stopper is in the open position, fluid can readily flow around the stopper 301 and out of the carafe 1. The user pushes the actuating button 304 to compress the spring 302. The stopper 301 is lowered, opening the channel for fluid to flow out of the carafe 1. Fluid flows from the main body 10, past the stopper 301, through slots 305 in the lower portion of the stopper body 306. The fluid can then be consumed directly by the user, or poured into a serving pitcher.

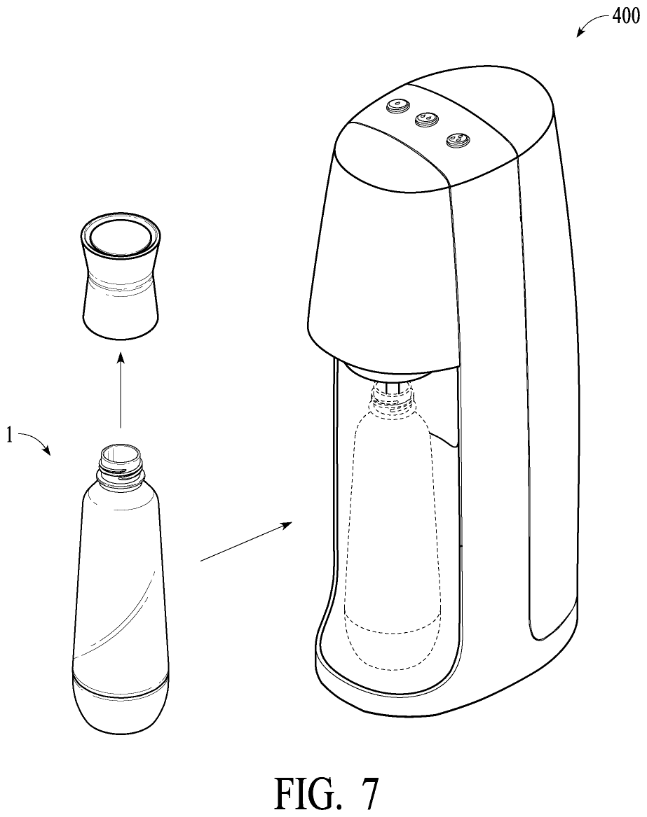

The arrangement of the actuating button 304 provides several advantages to the user. The beverage can be consumed with the user touching only the cap 30. This is a hygiene advantage in that the element that touches the mouth of a user, the top of the cap 30, does not touch a filling and carbonation station. Only the top of the main body 10 touches those mechanisms. FIG. 7 illustrates the interaction of the carafe 1 with a typical filling and carbonation station.

It should also be noted that opening the cap 30 and pouring out the contents allows the carafe 1 to serve as an aerator for the beverage. Since the liquid pours slowly through the lid, the liquid bubbles more as the cap 30 is opened and the liquid leaves the carafe. Moreover, the structure of the actuating button 304 in the cap 30 allows a user to open the carafe and pour the beverage with one hand. If the beverage includes fruits or infusers, the cap inhibits them from spilling into the glass of the user.

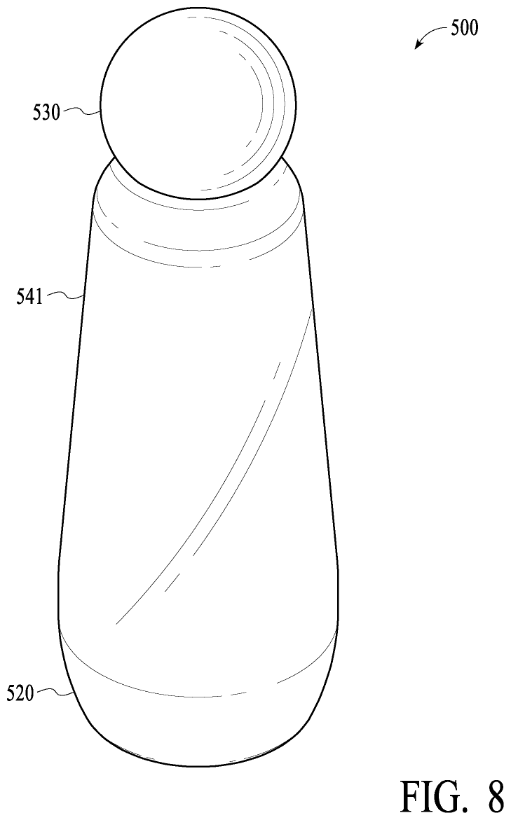

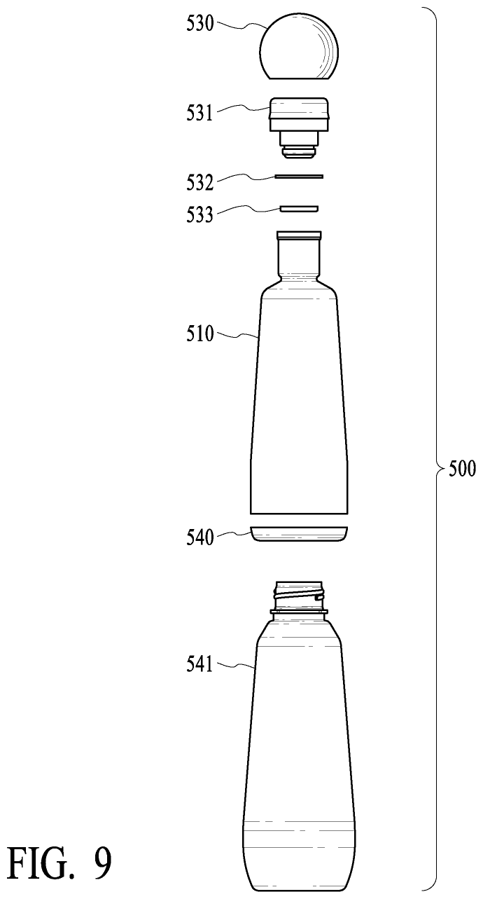

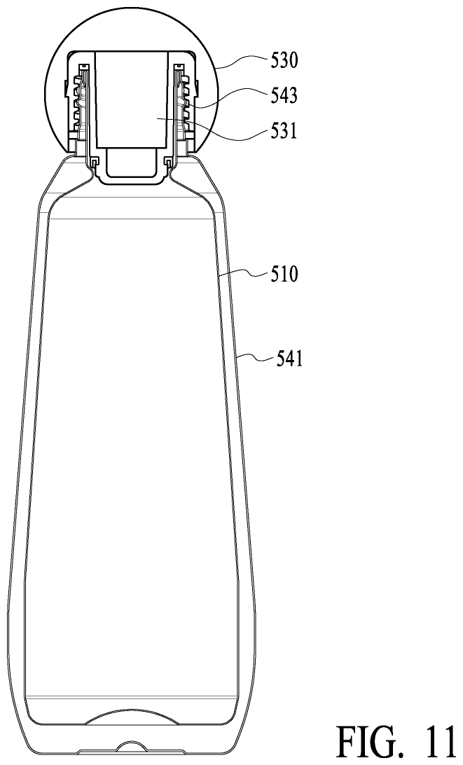

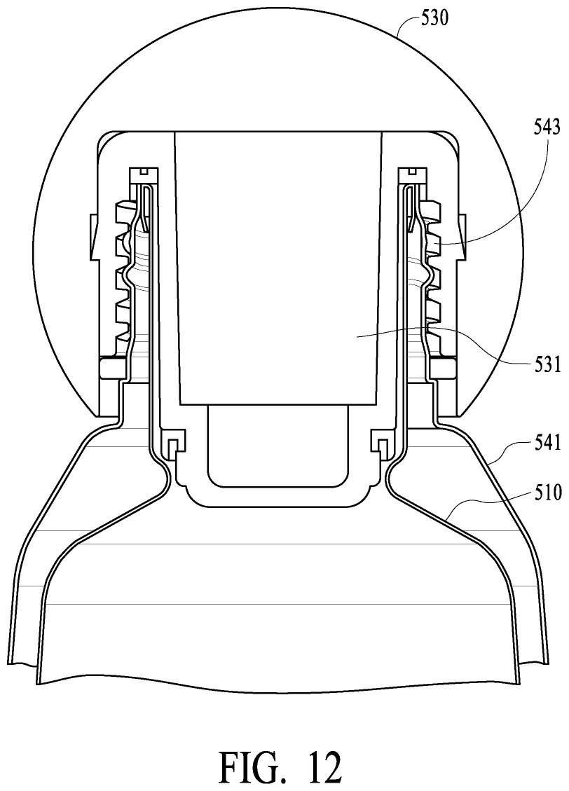

A carafe 500 can be modified to include a double wall construction for improved insulation and a modified cap, as is illustrated in FIGS. 8-13. FIG. 9 shows an exploded view of the components of the device. A top piece 530 of the cap is mostly ornamental, but does help the user grip a stopper 531. A first seal 532 and a second seal 533 seal the opening to an inner wall 510 chamber. The inner wall 510, an outer wall 541, and a base 540 are all welded into a unitary device. The inner wall 510 and the outer wall 541 provide a double wall construction which maximizes the insulating capability of the device.

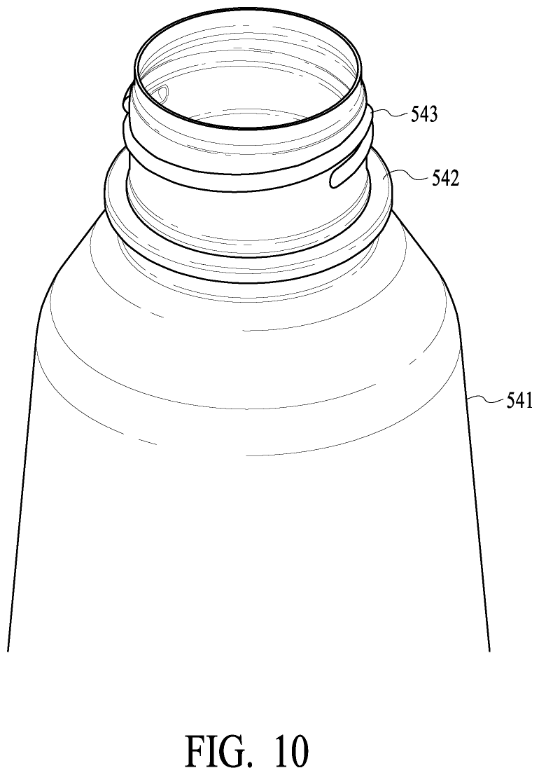

The outer wall 541 includes a protrusion 542 which receives the stopper 531. Male threads 543 mate with female threads in the interior of the top piece 530 of the cap. See FIGS. 10-12.

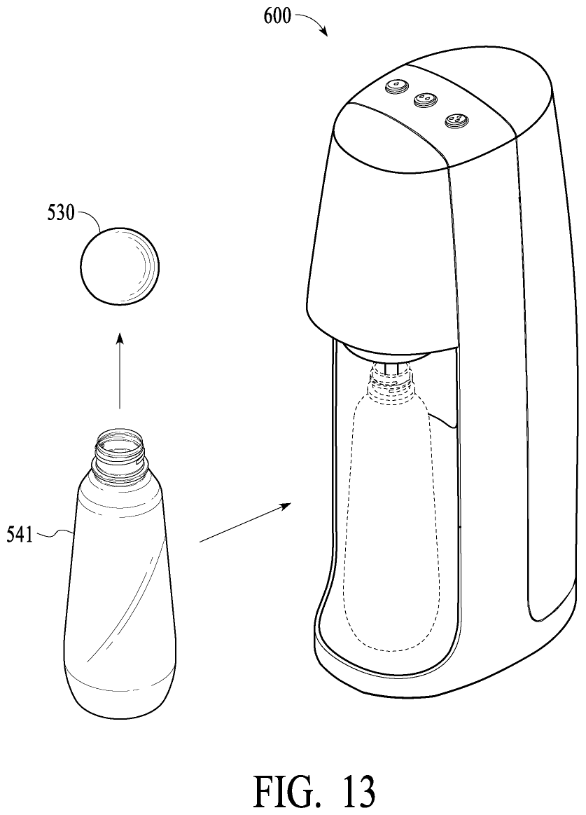

As illustrated in FIG. 13, the carafe 500 is designed to be received in a filling and carbonation station 600. When placed in the station 600, the carafe is able to receive carbonated and non-carbonated liquids.

The technology disclosed herein addresses improved carbonated beverage containers. The improvements disclosed are independent of the actual materials used. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

In the foregoing description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A vessel adapted to contain liquids, the vessel comprising:
a main body;
a base element; and
a cap that is removably secured to the main body with a threaded connection so as to form an airtight seal; wherein
the base is secured to a lower end of the main body and is adapted to encase, support and stabilize the main body,
an upper end of the main body includes a male thread that mates with a female thread on the cap, and further includes a base ring that provides an anchor point for the cap and further provides a mechanism for the vessel to be used in conjunction with various carbonating devices, thereby enabling a user to prepare carbonated beverages in the vessel.

2. The vessel of claim 1, wherein:
the main body is formed from two cylindrical members welded together, thereby forming a double wall construction that maximizes insulating capability.

3. The vessel of claim 1, wherein:
the main body is welded to a base, so that the two cylindrical members and the base form a unitary double walled vessel.

4. The vessel of claim 1, wherein:
the cap includes a stopper that seals an opening in the top of the main body when the stopper is in a closed position, the stopper moving to an open position when a user applies pressure to an actuating button so that liquid flows out of the vessel, the stopper being spring loaded so that the stopper returns to the closed position when the user releases pressure on the actuating button.

5. The vessel of claim 4, wherein:
the vessel is sized so that an average human hand can hold the main body of the vessel while operating the actuating button, so that the user can pour liquid from the vessel using only one hand.

6. The vessel of claim 1, wherein:
multiple caps are provided with the vessel, individual ones of the caps varying in color and conformation, so that multiple color combinations and styles are created for the vessel by using different ones of the cap.

7. The vessel of claim 1, wherein:
the main body includes a visible fill line.

8. The vessel of claim 1, wherein:
the base includes at least one drain hole to release liquid.

9. A vessel adapted to contain liquids, the vessel comprising:
a main body;
a base element; and
a cap that is removably secured to the main body with a threaded connection so as to form an airtight seal; wherein
the base is secured to a lower end of the main body and is adapted to encase, support and stabilize the main body, the main body being formed from two cylindrical members welded together, thereby forming a double wall construction that maximizes insulating capability; and
an upper end of the main body includes a male thread that mates with a female thread on the cap, and further includes a base ring that provides an anchor point for the cap and further provides a mechanism for the vessel to be used in conjunction with various carbonating devices, thereby enabling a user to prepare carbonated beverages in the vessel.

10. The vessel of claim 9, wherein:
the main body is welded to a base, so that the two cylindrical members and the base form a unitary double walled vessel.

11. The vessel of claim 9, wherein:
the cap includes a stopper that seals an opening in the top of the main body when the stopper is in a closed position, the stopper moving to an open position when a user applies pressure to an actuating button so that liquid flows out of the vessel, the stopper being spring loaded so that the stopper returns to the closed position when the user releases pressure on the actuating button.

12. The vessel of claim 11, wherein:
the vessel is sized so that an average human hand can hold the main body of the vessel while operating the actuating button, so that the user can pour liquid from the vessel using only one hand.

13. The vessel of claim 9, wherein:
multiple caps are provided with the vessel, individual ones of the caps varying in color and conformation, so that multiple color combinations and styles are created for the vessel by using different ones of the cap.

14. The vessel of claim 9, wherein:
the main body includes a visible fill line.

15. The vessel of claim 9, wherein:
the base includes at least one drain hole to release liquid.
